(19) United States
(12) Patent Application Publication
(10) Pub. No.: US 2012/0131318 A1
(43) Pub. Date: May 24, 2012

(54) SERVER AND METHOD FOR PERFORMING DATA RECOVERY OF THE SERVER

(75) Inventor: ZI-YU ZHAN, Shenzhen City (CN)

(73) Assignees: HON HAI PRECISION INDUSTRY CO., LTD., Tu-Cheng (TW); HONG FU JIN PRECISION INDUSTRY (ShenZhen)CO., LTD., Shenzhen City (CN)

(21) Appl. No.: 13/155,315

(22) Filed: Jun. 7, 2011

(30) Foreign Application Priority Data
Nov. 23, 2010 (CN) 201010555657.6

(51) Int. Cl. G06F 15/177

(52) U.S. Cl. 713/2

(57) ABSTRACT

A method for performing data recovery of a server sends a data recovery request from a basic input output system (BIOS) of the server to a backup microchip of the server if a master operating system (OS) of an original microchip of the server is not available when the server is powered on, obtains a backup initial OS of the server from a storage unit of the backup microchip, and boots the backup initial OS according to a bootstrap of the backup initial OS. The method further obtains a backup master OS of the server from the storage unit of the backup microchip, sends the backup master OS to the original microchip of the server, and restarts the server according to the backup master OS.

### BACKGROUND

1. Technical Field

Embodiments of the present disclosure relate to data management technology, and particularly to a server and method for performing data recovery of the server.

2. Description of Related Art

Redundant array of independent disk (RAID) have been used to store mass data of a server. A plurality of backup servers are connected to a master server, to prevent data loss from the master server due to unexpected accidents, such as a power failure, a hardware breakdown, and a hacker attack. Each of the backup servers stores a backup operating system (OS) of the master server at each preset time interval (e.g., ten minutes). When an accident occurs in the master server, the master server may obtain the backup OS from one of the backup server to recover the master server. However, the above-mentioned method increases the cost of data recovery of the server because a plurality of backup servers are needed to be connected to the master server. Therefore, an efficient method for performing data recovery of a server is desired.

### BRIEF DESCRIPTION OF THE DRAWINGS

FIG. 1 is a block diagram of one embodiment of a data backup system.

FIG. 2 is a block diagram of one embodiment of a server including the data backup system.

FIG. 3 is a block diagram of one embodiment of a backup microchip of the data backup system.

FIG. 4 is a block diagram of one embodiment of a data backup module of the backup microchip.

FIG. 5 is a flowchart of one embodiment of a method for performing data recovery of the server using the data backup system.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

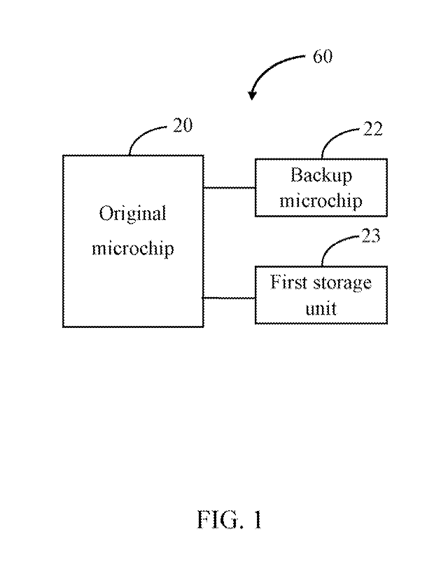

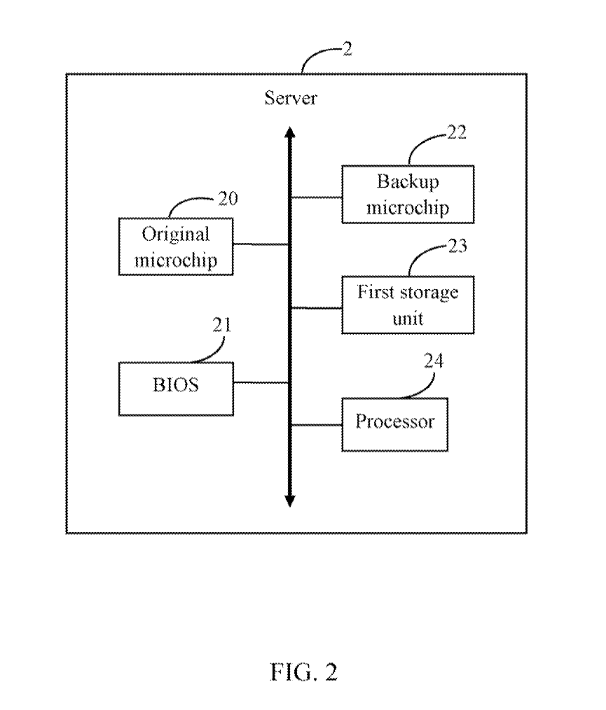

FIG. 1 is a block diagram of one embodiment of a data backup system 60. In one embodiment, the data backup system 60 includes an original microchip 20, a backup microchip 22, and a first storage unit 23. As shown in FIG. 2, the server includes the backup system 60. The server 2 further includes a basic input output system (BIOS) 21 and at least one processor 24. The original microchip 20 is used to store a master operating system (OS) of the server 2, the backup microchip 22 is used to store a plurality of backup master operating systems of the server 2, and the first storage unit 23, such as a hard disk, is used to store various data (e.g., images) of the server 2. The data backup system 60 is used to perform data recovery of the server 2 when the master OS in the original microchip 20 is damaged. A detailed description will be given in the following paragraphs.

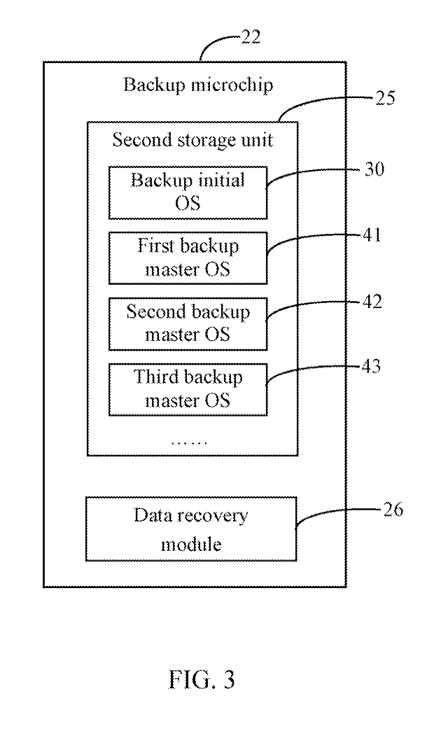

FIG. 3 is a block diagram of one embodiment of the backup microchip 22. In one embodiment, the backup microchip 22 includes a second storage unit 25 and a data recovery module 26. The second storage unit 25 includes a backup initial OS 30 of the server 2 and a plurality of backup master operating systems of the server 2, such as a first backup master OS 41, a second backup master OS 42, and a third backup master OS 43. In one embodiment, the backup initial OS 30 does not provide any application programs, and the backup master OS installs one or more application programs. The second storage unit 25 may be flash memory.

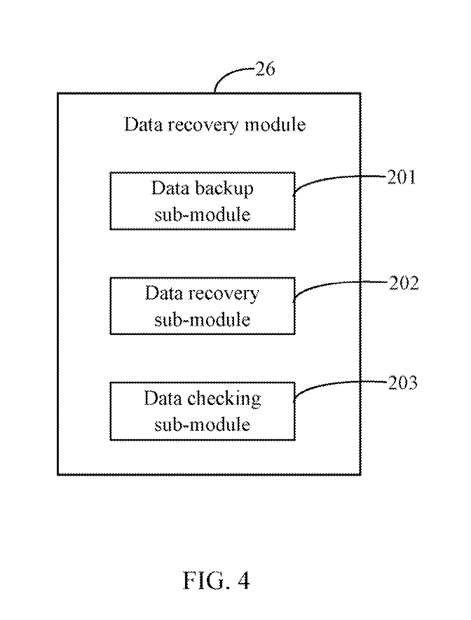

As shown in FIG. 4, in one embodiment, the data recovery module 26 may include one or more sub-modules, for example, a data backup sub-module 201, a data recovery sub-module 202, and a data checking sub-module 203. The one or more modules 201-203 may comprise computerized code in the form of one or more programs that are stored in the first storage unit 23 (or memory). The computerized code includes instructions that are executed by the at least one processor 24 to provide functions for the one or more modules 201-203.

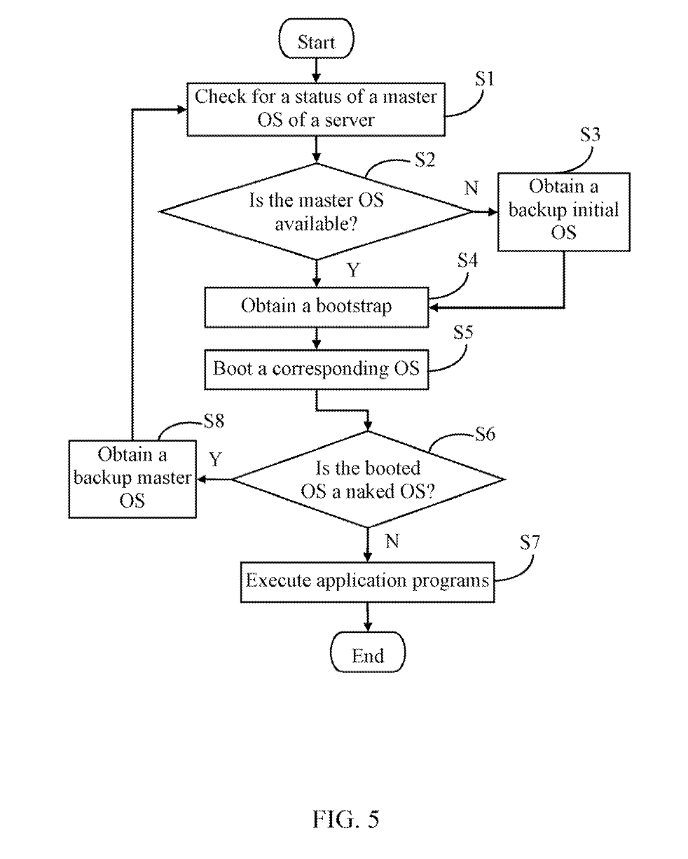

FIG. 5 is a flowchart of one embodiment of a method for performing data recovery of the server 2. Depending on the embodiment, additional blocks may be added, others removed, and the ordering of the blocks may be changed.

In block S1, the BIOS 21 checks for a status of a master OS in the original microchip 20 of the server 2 when the server 2 is powered on. In one embodiment, the status of the master OS in the original microchip 20 may include, but is not limited to, an available status and an un-available status. For example, if the BIOS 21 does not obtain a bootstrap of the master OS, the master OS in the original microchip 20 is determined to be under the un-available status. If the BIOS 21 obtains the bootstrap of the master OS, the master OS in the original microchip 20 is determined to be under the available status.

In block S2, the BIOS 21 determines if the master OS in the original microchip 20 is available according to a check result in block 51. If the status of the master OS in the original microchip 20 is un-available, the BIOS 21 determines that the master OS is un-available, and sends a data recovery request to the backup microchip 22 of the server 2, and the procedure goes to block S3. If the status of the master OS in the original microchip 20 is available, the BIOS 21 determines that the master OS is available, and the procedure goes to block S4.

In one embodiment, the data backup sub-module 201 backups the master OS of the server 2 at each preset time interval (e.g., five minutes), and stores the backup master OS in the second storage unit 25 of the backup microchip 22. If a number of the backup master OS stored in the second storage unit 25 achieves a threshold value (e.g., 10), the data backup sub-module 201 overwrites a selected backup master OS stored in the second storage unit 25 with a new backup master OS. In one embodiment, the selected backup master OS is the one that is earliest stored in the second storage unit 25. For example, the data backup sub-module 201 overwrites the first backup master OS 41 with an eleventh backup master OS.

In block S3, the data recovery sub-module 202 obtains the backup initial OS 30 of the server 2 from the second storage unit 25 of the backup microchip 22 when the backup microchip 22 receives the data recovery request, and the procedure goes to block S4.

In block S4, if the master OS in the original microchip 20 is available, the BIOS 21 obtains the bootstrap of the master OS in the original microchip 20, or if the master OS in the original microchip 20 is un-available, the BIOS 21 obtains a bootstrap of the backup initial OS 30.

In block S5, if the master OS in the original microchip 20 is available, the BIOS 21 boots the master OS according to the bootstrap of the master OS in the original microchip 20. If the master OS in the original microchip 20 is un-available, the BIOS 21 boots the backup initial OS 30 according to the bootstrap of the backup initial OS 30.

In block S6, the data checking sub-module 203 determines if the master OS or the backup initial OS 30 is a naked OS. In one embodiment, the naked OS refers to an OS providing no application programs. That is to say, the master OS is not the naked OS, and the backup initial OS 30 is the naked OS. Thus, if the master OS in the original microchip 20 is available, the procedure goes to block S7 because the master OS is not the naked OS. If the master OS in the original microchip 20 is un-available, the procedure goes to block S8 because the backup initial OS 30 is the naked OS.

In block S7, the server 2 executes the application programs installed in the master OS of the original microchip 20.

In block S8, the data recovery sub-module 202 obtains a backup master OS (e.g., the third backup master OS 43) of the server 2 from the second storage unit 25 of the backup microchip 22, sends the backup master OS to the original microchip 20 of the server 2, restarts the server 2 according to the backup master OS, and the procedure returns to block S1.

In one embodiment, the data recovery sub-module 202 obtains a backup master OS lastly stored in the second storage unit 25 of the backup microchip 22. For example, if a backup time of the first backup master OS 41 is 10:20, a backup time of the second backup master OS 42 is 10:25, a backup time of the third backup master OS 43 is 10:30. The data recovery sub-module 202 obtains the third backup master OS 43, and sends the third backup master OS to the original microchip 20 of the server 2.

In other embodiments, if the third backup master OS 43 is still not available, the data recovery sub-module 202 obtains the second backup master OS 42 to restart the server 2. If the second backup master OS 42 is still not available, the data recovery sub-module 202 obtains the first backup master OS 41 until each of the backup master operating systems stored in the second storage unit 25 of the backup microchip 22 has been tried to restart the server 2.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for performing data recovery of a server, the method comprising:
sending a data recovery request from a basic input output system (BIOS) of the server to a backup microchip of the server upon the condition that a master operating system (OS) of the server is not available when the server is powered on, the master OS being installed in an original microchip of the server;
obtaining a backup initial OS of the server from a storage unit of the backup microchip when the backup microchip receives the data recovery request;
obtaining a bootstrap of the backup initial OS by the BIOS, and booting the backup initial OS according to the bootstrap; and
obtaining a backup master OS of the server from the storage unit of the backup microchip, sending the backup master OS to the original microchip of the server, and restarting the server according to the backup master OS.

2. The method according to claim 1, wherein the backup microchip backups the master OS of the server at each preset time interval.

3. The method according to claim 2, wherein the backup microchip overwrites a selected backup master OS stored in the storage unit with a new backup master OS upon the condition that a number of the backup master OS of the server achieves a threshold value.

4. The method according to claim 3, wherein the selected backup master OS is the one that is earliest stored in the storage unit of the backup microchip.

5. The method according to claim 3, wherein the step of obtaining a backup master OS of the server from the storage unit of the backup microchip comprises: obtaining a backup master OS lastly stored in the storage unit of the backup microchip.

6. The method according to claim 1, wherein the backup initial OS does not provide any application programs, and the backup master OS installs one or more application programs.

7. A server, comprising:
an original microchip;
a backup microchip;
a storage device;
at least one processor; and
one or more modules that are stored in the storage device and are executed by the at least one processor, the one or more modules comprising instructions:
to send a data recovery request from a basic input output system (BIOS) of the server to a backup microchip of the server upon the condition that a master operating system (OS) of the server is not available when the server is powered on, the master OS being installed in an original microchip of the server;
to obtain a backup initial OS of the server from a storage unit of the backup microchip when the backup microchip receives the data recovery request;
to obtain a bootstrap of the backup initial OS by the BIOS, and boot the backup initial OS according to the bootstrap; and
to obtain a backup master OS of the server from the storage unit of the backup microchip, send the backup master OS to the original microchip of the server, and restart the server according to the backup master OS.

8. The server according to claim 7, wherein the backup microchip backups the master OS of the server at each preset time interval.

9. The server according to claim 8, wherein the backup microchip overwrites a selected backup master OS stored in the storage unit with a new backup master OS upon the condition that a number of the backup master OS of the server achieves a threshold value.

10. The server according to claim 9, wherein the selected backup master OS is the one that is earliest stored in the storage unit of the backup microchip.

11. The server according to claim 9, wherein the instruction of obtaining a backup master OS of the server from the storage unit of the backup microchip comprises: obtaining a backup master OS lastly stored in the storage unit of the backup microchip.

12. The server according to claim 7, wherein the backup initial OS does not provide any application programs, and the backup master OS installs one or more application programs.

13. A non-transitory storage medium having stored thereon instructions that, when executed by a processor of a server, causes the processor to perform a method for performing data recovery of a server, the method comprising:
sending a data recovery request from a basic input output system (BIOS) of the server to a backup microchip of the server upon the condition that a master operating system (OS) of the server is not available when the server is powered on, the master OS being installed in an original microchip of the server;
obtaining a backup initial OS of the server from a storage unit of the backup microchip when the backup microchip receives the data recovery request;
obtaining a bootstrap of the backup initial OS by the BIOS, and booting the backup initial OS according to the bootstrap; and
obtaining a backup master OS of the server from the storage unit of the backup microchip, sending the backup master OS to the original microchip of the server, and restarting the server according to the backup master OS.

14. The non-transitory storage medium according to claim 13, wherein the backup microchip backups the master OS of the server at each preset time interval.

15. The non-transitory storage medium according to claim 14, wherein the backup microchip overwrites a selected backup master OS stored in the storage unit with a new backup master OS upon the condition that a number of the backup master OS of the server achieves a threshold value.

16. The non-transitory storage medium according to claim 15, wherein the selected backup master OS is the one that is earliest stored in the storage unit of the backup microchip.

17. The non-transitory storage medium according to claim 15, wherein the step of obtaining a backup master OS of the server from the storage unit of the backup microchip comprises: obtaining a backup master OS lastly stored in the storage unit of the backup microchip.

18. The non-transitory storage medium according to claim 13, wherein the backup initial OS does not provide any application programs, and the backup master OS installs one or more application programs.

19. The non-transitory storage medium according to claim 13, wherein the medium is selected from the group consisting of a hard disk drive, a compact disc, a digital video disc, and a tape drive.
